(19) United States
(12) Patent Application Publication
(10) Pub. No.: US 2026/0138254 A1
(43) Pub. Date: May 21, 2026

(54) Drive cylinder unit for a power tool, power tool

(71) Applicant: Hilti Aktiengesellschaft, Schaan (LI)

(72) Inventors: Joshua FLECK, München (DE); Benedikt NAGEL, Dießen am Ammersee (DE)

(21) Appl. No.: 19/378,008

(22) Filed: Nov. 3, 2025

(30) Foreign Application Priority Data
Nov. 18, 2024 (EP) 24213476.5

(51) Int. Cl. B25D 11/06

(52) U.S. Cl. CPC B25D 11/062; B25D 2211/061; B25D 2250/181

(57) ABSTRACT

A drive cylinder unit for a power tool having a striking mechanism, in particular a pneumatic striking mechanism, having a drive cylinder that is accommodated in a guide tube so as to be axially movable between a front and a rear end position, which drive cylinder is designed to be fork-shaped at one end and forms two arms, in each case having a mounting bore in which a mounting bolt is rotatably mounted, wherein the mounting bolt is penetrated perpendicular to its longitudinal axis by a bore for accommodating a pin of a swash plate bearing. The drive cylinder is axially preloaded in the direction of the rear end position via a spring element. A power tool having a striking mechanism, in particular a pneumatic striking mechanism, having a drive cylinder unit is also provided.

This claims priority to European Patent Application EP 24213476.5, filed November 18, 2024 which is hereby incorporated by reference herein.

The invention relates to a drive cylinder unit for a power tool having a striking mechanism, in particular a pneumatic striking mechanism. Furthermore, the invention relates to a power tool having a striking mechanism, which has a drive cylinder unit according to the invention.

The field of application of the invention is primarily hand-held power tools, in particular drills and/or chisel hammers. These have a striking mechanism for applying the necessary impact energy to the particular tool.

### BACKGROUND

Power tools having a striking mechanism are well known. In a pneumatic striking mechanism, a drive cylinder and a striking piston are operatively connected via an air spring, so that an axial displacement of the drive cylinder effects an axial displacement of the striking piston. For this purpose, the drive cylinder and the striking piston are guided in an axially movable manner in a guide tube, which together with the drive cylinder forms a drive cylinder unit.

The axial displacement of the drive cylinder is achieved via an electric motor-driven shaft. In order to convert the rotary motion of the shaft into a translational motion of the drive cylinder, the drive cylinder is connected to the shaft via a coupling device.

Such a coupling device is shown, for example, in DE 102020207591 A1. It comprises a pendulum rod that is connected at one end to a drive shaft via a pendulum bearing. At the other end, the pendulum rod is connected to a piston pin of a piston assembly, which is rotatably mounted in two spaced-apart piston arms of a piston body of the piston assembly. During operation, the pendulum rod moves relative to the piston arms.

### SUMMARY OF THE INVENTION

Coupling devices of the type mentioned above are subject to wear and thus limit the service life of the power tool. Wear occurs particularly in the contact region of the moving parts of the coupling device and the drive cylinder unit due to friction. This can result in defects that lead to increased play. Due to the increase in play, vibrations occur and the load in the contact regions is increased, as a result of which wear is further increased. Particles such as dust particles that penetrate into the contact region also increase wear. As a result of progressive wear, the power tool then fails.

An object of the present invention is to provide a drive cylinder unit for a power tool having a striking mechanism that is less susceptible to wear, so that the service life of the power tool increases.

The present invention provides a drive cylinder unit for a power tool having a striking mechanism, in particular a pneumatic striking mechanism, having a drive cylinder that is accommodated in a guide tube so as to be axially movable between a front and a rear end position, which drive cylinder is designed to be fork-shaped at one end and forms two arms, in each case having a mounting bore in which a mounting bolt is rotatably mounted. The mounting bolt is penetrated perpendicular to its longitudinal axis by a bore for accommodating a pin of a swash plate bearing. According to the invention, the drive cylinder is axially preloaded in the direction of the rear end position by means of a spring element.

The axial preload of the drive cylinder in the direction of the rear end position eliminates the play between the moving parts of the drive cylinder unit. As a result, vibrations along with the high loads caused by vibrations in the contact regions decrease. As a result, wear can be reduced and the service life of the power tool having the drive cylinder unit can be extended.

In principle, the spring element used for the axial preload of the drive cylinder can be designed in any way. This means that, in principle, any elastic component can be used as a spring element. For example, the spring element can be a coil or leaf spring.

According to a preferred embodiment of the invention, the spring element is designed as a tension spring, in particular as a helical tension spring. Such spring elements are simple and inexpensive to produce, so that the invention can be implemented cost-effectively. In addition, the axial preload force can be easily set via the design of the helical tension spring.

Furthermore, it is proposed that the spring element is connected to the drive cylinder via a sheet metal part. The sheet metal part facilitates the connection of the spring element to the drive cylinder. Preferably, the sheet metal part is arranged between the two arms of the drive cylinder and held in the drive cylinder via the mounting bolt. Therefore, additional connecting or fastening elements for fixing the sheet metal part to the drive cylinder are unnecessary. As a result, the installation of the sheet metal part is facilitated. In this arrangement, the sheet metal part can also replace two washers that are usually arranged between the drive cylinder and the pin accommodated in the mounting bolt for reducing wear in the contact region.

Preferably, the sheet metal part is designed to be substantially U-shaped and in each case has an opening in the region of two side walls arranged in parallel for accommodating the mounting bolt. The substantially U-shaped sheet metal part can be inserted between the two arms of the drive cylinder in such a way that the two side walls of the sheet metal part that are arranged in parallel come into contact with the arms of the drive cylinder and the openings formed in the side walls cover the mounting bores formed in the arms. Due to the subsequent insertion of the mounting bolt into the mounting bores of the arms and into the openings of the side walls of the sheet metal part, the sheet metal part can then be fixed in the drive cylinder. The two side walls arranged in parallel in this arrangement also make it possible to eliminate the need for the two washers that are usually provided.

Furthermore, the side walls of the sheet metal part that are arranged in parallel preferably have, at their end facing the spring element, further openings for inserting, in particular for screwing in, a spring end of the spring element. Advantageously, the further openings are formed in portions of the two side walls, which are recessed with respect to the outer side of the two side walls arranged in parallel. As a result, it is ensured that the spring end of the spring element does not protrude laterally beyond the sheet metal part and come into contact with the arms of the drive cylinder.

Furthermore, the two side walls arranged in parallel of the sheet metal part are preferably connected via a rear wall that, at the level of the spring element, has a recess for inserting a tool through the sheet metal part up to or into the spring element. Inserting the tool facilitates the housing-side fastening of the spring element. For example, the housing-side fastening can be established using a screw as a fastening device. A screwdriver can then be inserted into the spring element through the rear-side recess of the sheet metal part in order to screw the screw into a housing-side receptacle.

Furthermore, a power tool having a striking mechanism, in particular a pneumatic striking mechanism, is proposed, wherein the striking mechanism has a drive cylinder unit according to the invention. The drive cylinder unit according to the invention reduces vibrations and thus wear in the contact regions of the parts that move relative to one another. The service life of the power tool increases accordingly. Preferably, the spring element is fastened to a housing at its spring end facing away from the drive cylinder by means of a screw, wherein further preferably a washer is arranged between the screw and the housing. The washer makes it possible for the spring end to be clamped between the screw and the housing, so that it is held securely to the housing. Alternatively, the spring element can be connected to the drive cylinder via a sheet metal part. The sheet metal part can in particular be designed to be U-shaped and have two side walls arranged in parallel, in which in each case an opening is formed for accommodating a mounting bolt of the drive cylinder unit. The sheet metal part can then be fixed in the drive cylinder via the mounting bolt.

Preferably, a pin of a swash plate bearing is accommodated in the bore of the mounting bolt, via which pin the drive cylinder is operatively connected to a shaft arranged parallel to the drive cylinder. In this way, the rotary motion of the shaft can be converted into a translational motion of the drive cylinder.

Furthermore, the swash plate bearing preferably has an inner ring arranged on the shaft and an outer ring mounted on the inner ring via mounting balls, on which outer ring the pin is arranged on the outer circumference. The mounting of the outer ring via mounting balls on the inner ring makes a swash motion of the outer ring possible with respect to the inner ring, so that the pin connected to the outer ring performs a kind of pendulum motion. Through this pendulum motion, the drive cylinder is moved back and forth.

### BRIEF DESCRIPTION OF THE DRAWINGS

A preferred embodiment of the invention is described in more detail below with reference to the accompanying drawings. In the drawings:

FIG. 1 is a longitudinal section through a power tool according to the invention having a drive cylinder unit according to the invention,

FIG. 2 is an exploded view of the spring element for the axial preload of the drive cylinder of the drive cylinder unit including a sheet metal part and fastening means,

FIG. 3 is a side view of the sheet metal part of FIG. 2 having a mounted spring element,

FIG. 4 is a perspective view of the sheet metal part including the spring element during connection to the drive cylinder of the drive cylinder unit and

FIG. 5 is a perspective view of the drive cylinder after connection to the sheet metal part including the spring element.

### DETAILED DESCRIPTION OF THE DRAWINGS

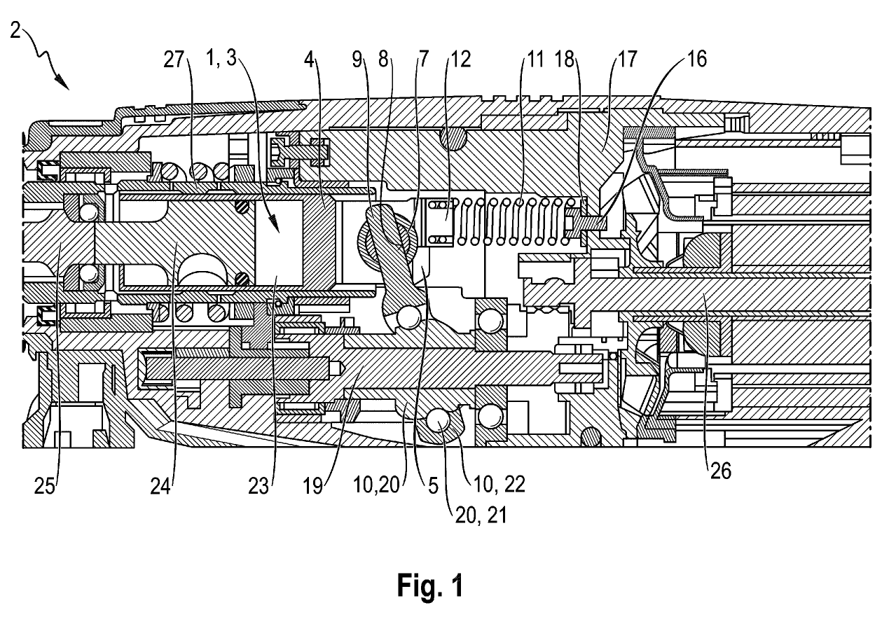

FIG. 1 shows a power tool 2 according to the invention in sections with a pneumatic striking mechanism 3. The pneumatic striking mechanism 3 has a drive cylinder unit 1 according to the invention, comprising a guide tube 27 in which a drive cylinder 4 is accommodated so as to be axially movable between a front and a rear end position. The drive cylinder 4 is operatively connected to a striking piston 24 via an air spring 23, so that an axial displacement of the drive cylinder 4 effects an axial displacement of the striking piston 24. The striking piston 24 in turn acts on a striker 25, which in turn acts on a tool not shown in FIG. 1.

The axial displacement of the drive cylinder 4 is effected with the aid of an electric motor-driven shaft 19, wherein the shaft 19 is an intermediate shaft that is connected to a motor shaft 26. In order to convert the rotary motion of the shaft 19 into a translational motion of the drive cylinder 4, a swash plate bearing 10 having a pin 9 is arranged on the shaft 19. The pin 9 is accommodated at its end facing away from the swash plate bearing 10 in a bore 8 of a mounting bolt 7, which is rotatably mounted via mounting bores 6 in the drive cylinder 4. For this purpose, the drive cylinder 4 has an end that is designed to be fork-shaped, so that two arms 5 are formed in which the mounting bores 6 are arranged. The swash plate bearing 10 has an inner ring 20, which is arranged on the shaft 19 and is connected to the shaft 19 in a rotationally fixed manner. An outer ring 22 is mounted on the inner ring 20 via mounting balls 21, to which outer ring the pin 9 is fastened, so that the pin 9 is arranged radially in relation to the outer ring 22. During a rotary motion of the shaft 19, the swash plate bearing 10 causes the pin 9 to move in a pendulum motion, which in turn moves the drive cylinder 4 back and forth in the axial direction between the front and rear end positions.

In the drive cylinder unit 1 according to the invention shown, the drive cylinder 4 is axially preloaded in the direction of the rear end position by means of a spring element 11. The preload eliminates the play between the parts moving relative to one another, so that vibrations and thus wear in the contact regions are reduced. For the axial preload of the drive cylinder 4 in the direction of the rear end position, in the present case, the spring element 11 is designed as a helical tension spring. The helical tension spring is connected, on the one hand, to the drive cylinder 4 via a sheet metal part 12 and, on the other hand, to a housing 17 via a screw 16 and a washer 18.

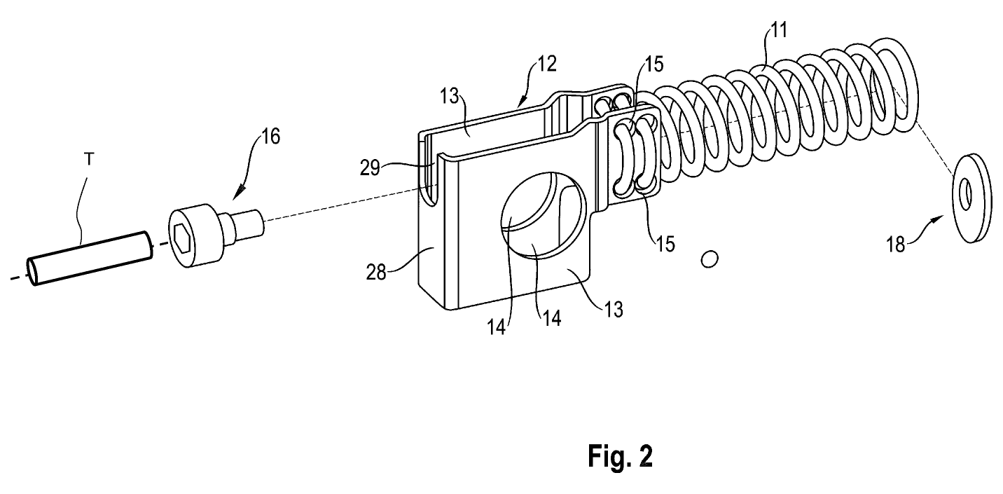

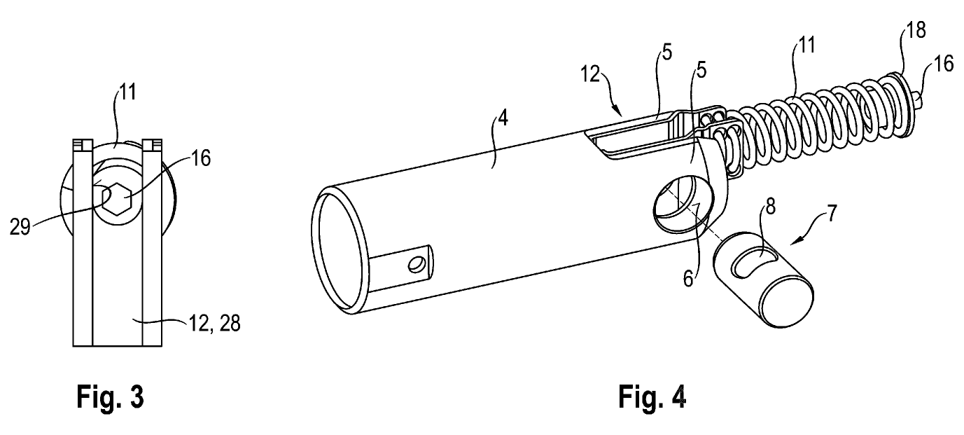

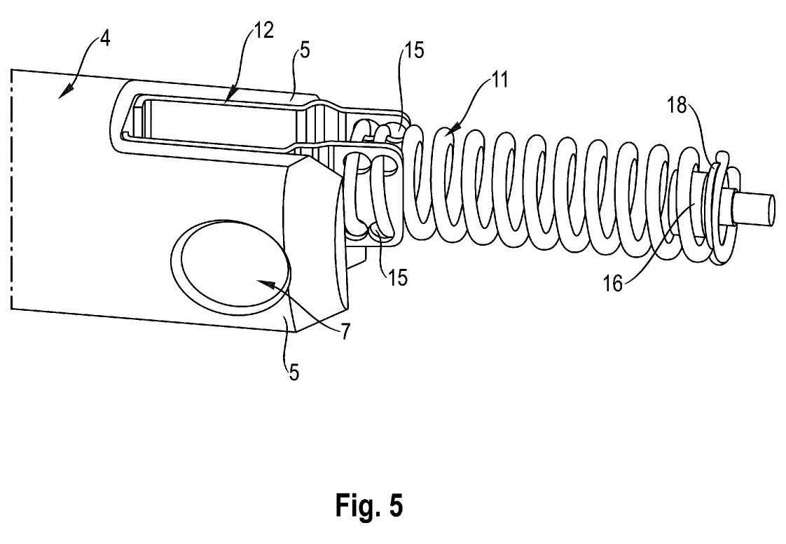

As can be seen in particular from FIG. 2, the sheet metal part 12 is designed to be substantially U-shaped. The sheet metal part 12 therefore has two side walls 13 arranged in parallel along with a rear wall 28 connecting them. A recess 29 is provided in the rear wall 28 through which a tool T (shown solely schematically) can be inserted into the spring element 11. With the aid of the tool, the screw 16 can be screwed into a corresponding receptacle in the housing 17. The spring end of the spring element 11 facing the housing 17 is clamped between the screw 16 and the housing 17 via the washer 18 (see also FIG. 3). The other spring end of the spring element 11 is inserted or screwed into openings 15 of the sheet metal part 12. In addition, the sheet metal part 12 has openings 14 in the region of the two side walls 13 arranged in parallel, which can be brought into overlap with the mounting bores 6 of the two arms 5 of the drive cylinder 4 during installation of the sheet metal part 12 (see FIG. 4). Due to the subsequent insertion of the mounting bolt 7 into the mounting bores 6 of the arms 5 and into the openings 14 of the two side walls 13 of the sheet metal part 12, the sheet metal part 12 can then be fixed in the drive cylinder 4. FIG. 5 shows the drive cylinder 4 with the sheet metal part 12 inserted and fixed.

### LIST OF REFERENCE SIGNS

1 Drive cylinder unit

2 Power tool

3 Striking mechanism

4 Drive cylinder

5 Arm

6 Mounting bore

7 Mounting bolt

8 Bore

9 Pin

10 Swash plate bearing

11 Spring element

12 Sheet metal part

13 Side wall

14 Opening

15 Opening

16 Screw

17 Housing

18 Washer

19 Shaft

20 Inner ring

21 Mounting ball

22 Outer ring

23 Air spring

24 Striking piston

25 Striker

26 Motor shaft

27 Guide tube

28 Rear wall

29 Recess

T Tool

What is claimed is:

1. A drive cylinder unit for a power tool having a striking mechanism, the drive cylinder unit comprising:
a drive cylinder accommodated in a guide tube so as to be axially movable between a front and a rear end position, the drive cylinder being fork-shaped at one end to define two arms, each of the two arms having a mounting bore, a mounting bolt being rotatably mounted in the mounting bore, the mounting bolt penetrated perpendicular to a longitudinal axis of the mounting bolt by a bore for accommodating a pin of a swash plate bearing,
the drive cylinder being axially preloaded in a direction of the rear end position via a spring.

2. The drive cylinder unit as recited in claim 1 wherein the spring is a tension spring.

3. The drive cylinder unit as recited in claim 1 wherein the spring s a helical tension spring.

4. The drive cylinder unit as recited in claim 1 wherein the spring is connected to the drive cylinder via a sheet metal part.

5. The drive cylinder unit as recited in claim 4 wherein the sheet metal part is arranged between the two arms of the drive cylinder and is held in the drive cylinder via the mounting bolt.

6. The drive cylinder unit as recited in claim 4 wherein the sheet metal part is U-shaped to define two side walls arranged in parallel, each side wall having an opening for accommodating the mounting bolt.

7. The drive cylinder unit as recited in claim 6 wherein the side walls have, at an end facing the spring, further openings for inserting a spring end of the spring.

8. The drive cylinder unit as recited in claim 6 wherein the side walls have, at an end facing the spring, further openings for screwing in a spring end of the spring.

9. The drive cylinder unit as recited in claim 6 wherein the two side walls are connected via a rear wall having, at a level of the spring, a recess for inserting a tool through the sheet metal part up to or into the spring.

10. A power tool comprising:
a striking mechanism comprising the drive cylinder unit as recited in claim 1.

11. The power tool as recited in claim 10 further comprising a housing, the spring being fastened to the housing at a spring end facing away from the drive cylinder via a screw.

12. The power tool as recited in claim 11 further comprising a washer arranged between the screw and the housing.

13. The power tool as recited in claim 10 wherein the striking mechanism is a pneumatic striking mechanism.

14. The power tool as recited in claim 10 further comprising a pin of a swash plate bearing accommodated in the bore of the mounting bolt, the drive cylinder via the pin being operatively connected to a shaft arranged parallel to the drive cylinder.

15. The power tool as recited in claim 14 wherein the swash plate bearing has an inner ring arranged on the shaft and an outer ring mounted on the inner ring via mounting balls, the pin being arranged on an outer circumference of the outer ring.
